(19) United States
(12) Patent Application Publication
(10) Pub. No.: US 2021/0197199 A1
(43) Pub. Date: Jul. 1, 2021

(54) MICROFLUIDIC DEVICE CHANNEL LAYER

(71) Applicant: HEWLETT-PACKARD DEVELOPMENT COMPANY, L.P., Spring, TX (US)

(72) Inventors: Viktor SHKOLNIKOV, Palo Alto, CA (US); Michael W. CUMBIE, Corvallis, OR (US); Chien-Hua CHEN, Corvallis, OR (US)

(73) Assignee: HEWLETT-PACKARD DEVELOPMENT COMPANY, L.P., Houston, TX (US)

(21) Appl. No.: 16/076,553

(22) PCT Filed: Jul. 12, 2017
(86) PCT No.: PCT/US2017/041689

§ 371 Date: Aug. 8, 2018

(51) Int. Cl. B01L 3/00

(52) U.S. Cl. CPC B01L 3/502784; B01L 2300/0645; B01L 2300/0816; B01L 2300/0867; B01L 2200/0605; B01L 2300/123; B01L 2400/0406; B01L 2400/0688; B01L 2300/087

(57) ABSTRACT

A channel layer of a digital microfluidic device may include a number of sample wells located on a first side of the die, a number of first capillary channels fluidically coupled to each of the sample wells, the first capillary channels drawing a fluid from the sample wells using capillary forces, a capillary break fluidically coupled to each of the first capillary channels to dispense a portion of the fluid drawn from the sample wells through the capillary forces, a number of intermediate chambers fluidically coupled to the capillary break, a number of second capillary channels fluidically coupled to the intermediate chambers, the second capillary channels drawing the fluid from the intermediate chambers using capillary forces, and a number of mixing chambers fluidically coupled to the second capillary channels into which the capillary forces of the second capillary channels cause the fluid to enter the mixing chambers.

### BACKGROUND

Microfluidics as it relates to the sciences, may be defined as the manipulation and study of minute amounts of fluids. Microfluidic technologies and resultant devices may be used to obtain precise control and manipulation of fluids that are geometrically constrained to at least a sub-millimeter scale. Microfluidics may be applied in a number of disciplines including engineering, physics, chemistry, biochemistry, nanotechnology, and biotechnology, and, in some practical applications, may be used in the design of systems in which low volumes of fluids are processed to achieve multiplexing, automation, and high-throughput screening. For example, microfluidics may be used in sample preparation and analyte detection.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a channel layer of a microfluidic device, according to an example of the principles described herein.

FIG. 2 is a block diagram of a microfluidic electrode array, according to an example of the principles described herein.

FIG. 3 is a block diagram of a microfluidic system, according to an example of the principles described herein.

FIG. 4 is a block diagram of an electrode array moving a fluid, according to an example of the principles described herein.

FIG. 5 is a block diagram of a microfluidic device (500), according to another example of the principles described herein.

FIG. 6 is a diagram of a number of capillary channels, capillary breaks, and electrodes within box A of FIG. 5, according to an example of the principles described herein.

FIG. 7 is a diagram of a number of capillary channels, capillary breaks, and electrodes of FIG. 6 within box B of FIG. 6, according to an example of the principles described herein.

FIG. 8 is a diagram of a number of electrodes, according to an example of the principles described herein.

FIG. 9 is a diagram of a capillary flow of fluid through a capillary channel, according to an example of the principles described herein.

FIG. 10 is a diagram of a mixing chamber, according to an example of the principles described herein.

FIG. 11 is an exploded view of a microfluidic system, according to an example of the principles described herein.

FIG. 12 is an axonometric view of a microfluidic system, according to an example of the principles described herein.

FIG. 13 is a side view of a microfluidic system, according to an example of the principles described herein.

FIG. 14 is a block diagram of a microfluidic device (500), according to another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Microfluidic devices include aspects of micro-electro-mechanical systems (MEMS) devices and may include devices referred to as a “lab-on-chip” (LOC) or a “micro total analysis system” (μTAS). In one example, MEMS devices may be any device with at least sub-millimeter geometrical dimensions, and, in one example, micrometer geometrical dimensions.

Thus, in a microfluidic device, volumes of fluids that may be processed may be as extremely small as less than picoliters. A microfluidic device may integrate a total sequence of lab processes in a very small package to perform analysis on the fluids introduced therein.

A few methods of how to move fluids within a microfluidic device to perform useful operations such as mixing of a number of fluids and inducing chemical reactions may involve the use of external pumps, internal pumps, gas supplies to move internal microfluidic pumps, or the use of electroosmotic pumps that rely on the inducement of an electrical field to create flow or pressure of the fluids. These methods, however, may increase the overall size and manufacturing costs due to their inclusion of these fluid movement devices and the increase in, for example, the size of a silicon die to support these devices. Further, as to electroosmotic flow devices, the electric field used to move the fluids must be precisely tuned for a particular reagent to achieve the desired flow and may not produce a similar flow in other reagents or fluids.

Examples described herein provide a digital microfluidic electrode array (DMFEA). The DMFEA may include at one least one die including a number of electrodes disposed along a surface of the die. The DMFEA may further include a channel layer coupled to the die. The channel layer may include a number of sample wells located on a first side of the die, a number of first capillary channels fluidically coupled to each of the sample wells, the first capillary channels drawing a fluid from the sample wells using capillary forces, a capillary break fluidically coupled to each of the first capillary channels to dispense a portion of the fluid drawn from the sample wells through the capillary forces, a number of intermediate chambers fluidically coupled to the capillary break, a number of second capillary channels fluidically coupled to the intermediate chambers, the second capillary channels drawing the fluid from the intermediate chambers using capillary forces, and a number of mixing chambers fluidically coupled to the second capillary channels into which the capillary forces of the second capillary channels cause the fluid to enter the mixing chambers. The electrodes cause the fluid to move out of the first capillary channels through the capillary break, through the intermediate chambers, and into the second capillary channels.

The electrodes are positioned on the die based on a pattern. Further, in one example, the first capillary channels, the capillary breaks, the intermediate chambers, and the second capillary channels are positioned based on the pattern of the electrodes. The channel layer includes an overmold material overmolding at least a portion of the die and coplanar to a side of the die on which the electrodes are disposed. The overmold material may be an epoxy mold compound (EMC). The first capillary channels and second capillary channels may include a tapered geometry. Further, in one example, the intermediate chambers are open to atmosphere.

Examples described herein also provide a microfluidic system. The microfluidic system may include a digital microfluidic electrode array (DMFEA). The DMFEA may include at one least one die including a number of electrodes disposed along a surface of the die, and a channel layer. The channel layer may include a number of sample wells located on a first side of the die, a number of first capillary channels fluidically coupled to each of the sample wells, the first capillary channels drawing a fluid from the sample wells using capillary forces, a capillary break fluidically coupled to each of the first capillary channels to dispense a portion of the fluid drawn from the sample wells through the capillary forces, a number of intermediate chambers fluidically coupled to the capillary break, a number of second capillary channels fluidically coupled to the intermediate chambers, the second capillary channels drawing the fluid from the intermediate chambers using capillary forces, and a number of mixing chambers fluidically coupled to the second capillary channels into which the capillary forces of the second capillary channels cause the fluid to enter the mixing chambers. The electrodes cause the fluid to move out of the first capillary channels through the capillary break, through the intermediate chambers, and into the second capillary channels. The microfluidic system may further include a printed circuit assembly (PCA) electrically coupled to the electrodes, the PCA controlling the activation of the electrodes.

The channel layer includes an overmold material overmolding at least a portion of the die and coplanar to a side of the die on which the electrodes are disposed. The sample wells, the first capillary channels, the intermediate chambers, the second capillary channels, the mixing chambers, or combinations thereof are defined in the channel layer. A lid layer may be disposed within the microfluidic system between the die and the PCA. The lid layer includes a cyclic olefin copolymer (COC).

The microfluidic system may further include a number of blister packs fluidically coupled to the first capillary channels, the intermediate chambers, the second capillary channels, the mixing chambers, or combinations thereof. Further, the microfluidic system may include a number of sensors positioned relative to the first capillary channels, the intermediate chambers, the second capillary channels, the mixing chambers, or combinations thereof to detect a number of properties of the fluid.

Examples described herein also provide a channel layer of a digital microfluidic device. The channel layer may include a number of sample wells located on a first side of the die, a number of first capillary channels fluidically coupled to each of the sample wells, the first capillary channels drawing a fluid from the sample wells using capillary forces, a capillary break fluidically coupled to each of the first capillary channels to dispense a portion of the fluid drawn from the sample wells through the capillary forces, a number of intermediate chambers fluidically coupled to the capillary break, a number of second capillary channels fluidically coupled to the intermediate chambers, the second capillary channels drawing the fluid from the intermediate chambers using capillary forces, and a number of mixing chambers fluidically coupled to the second capillary channels into which the capillary forces of the second capillary channels cause the fluid to enter the mixing chambers. The first capillary channels and second capillary channels comprise a tapered geometry.

As used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may or may not be included in other examples.

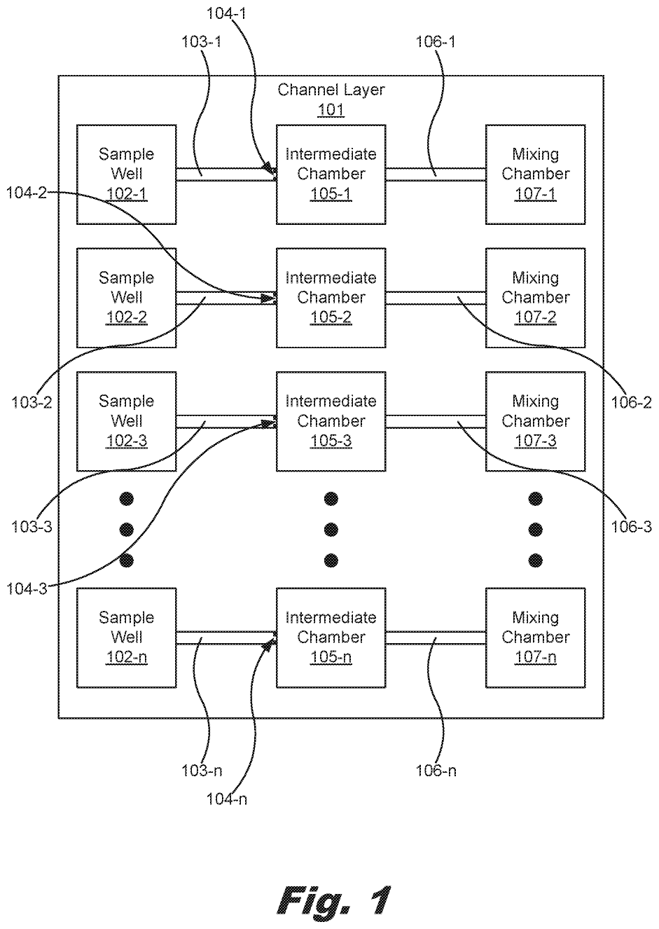

Turning now to the figures, FIG. 1 is a block diagram of a channel layer (101) of a microfluidic device, according to an example of the principles described herein. The channel layer (101) may be part of a microfluidic device such as a digital microfluidic device that provides for the movement of fluids throughout a number of channels, wells, and other fluid passages within the microfluidic device. Thus, the channel layer (101) may define, for example, a number of sample wells (102-1, 102-2, 102-3, 102-n, collectively referred to herein as 102), a number of first capillary channels (103-1, 103-2, 103-3, 103-n, collectively referred to herein as 103), a number of capillary breaks (104-1, 104-2, 104-3, 104-n, collectively referred to herein as 104), a number of intermediate chambers (105-1, 105-2, 105-3, 105-n, collectively referred to herein as 105), a number of second capillary channels (106-1, 106-2, 106-3, 106-n, collectively referred to herein as 106), and a number of mixing chambers (107-1, 107-2, 107-3, 107-n, collectively referred to herein as 107). Each of these elements will be described in more detail in turn.

The channel layer (101) may be made of any material into which the sample wells (102), the first capillary channels (103), the capillary breaks (104), the intermediate chambers (105), the second capillary channels (106), the mixing chambers (107), and other definable voids may be formed. In one example, the channel layer (101) may be made of an epoxy-based negative photoresist such as SU-8, a polycarbonate material, a molded polycarbonate material, an embossed polycarbonate material, an embossed topaz material, cyclic olefin copolymer (COC), or other void-definable material.

The various voids such as the sample wells (102), the first capillary channels (103), the capillary breaks (104), the intermediate chambers (105), the second capillary channels (106), the mixing chambers (107), and other definable voids may be formed in the channel layer (101) based on a desired function of the overall microfluidic device. In this example, the remaining elements of the microfluidic device may remain identical between types of microfluidic devices, but the channel layer (101) may be formed to create a desired function of the microfluidic device. Thus, the positions of the sample wells (102), the first capillary channels (103), the capillary breaks (104), the intermediate chambers (105), the second capillary channels (106), the mixing chambers (107), and other definable voids may be formed in the channel layer (101), and their respective routings may be designed to bring about the desired function of the microfluidic device. Thus, by adjusting or defining the single channel layer (101), the ability to form a microfluidic device with a desired capability or function may be obtained at a low cost and with minimal development.

The sample wells (102) may be any source of a fluid within an associated microfluidic device. For example, a plurality of fluids may be provided as reactants, analytes, or other fluid types within the microfluidic device. In this example, the plurality of fluids may be contained within a corresponding number of sample wells (102), and the individual fluids may be drawn from these sample wells (102) for, for example, analytical and reactant purposes.

The first (103) and second (106) capillary channels may be any channel that draws the fluids from a first well or chamber to another well or chamber. In one example, the first (103) and second (106) capillary channels may have any geometry that moves the fluids through capillary forces. Capillary forces provide the ability of a liquid to flow in narrow spaces without the assistance of, or even in opposition to, external forces like gravity. Capillary movement of fluids occurs because of intermolecular forces between the liquid and surrounding solid surfaces. If the geometry of the void through which the fluid may move is sufficiently small, then the combination of surface tension caused by cohesion within the liquid and adhesive forces between the liquid and container wall act to propel the liquid through the void. As is described in more detail herein, the fluids within the first (103) and second (106) capillary channels may be moved using a tapering geometry of the capillary channels (103, 106) where the direction of fluid movement is in the direction of the narrowing portion of the capillary channels (103, 106).

The capillary breaks (104) serve to allow a discrete portion or amount of the fluid to be drawn from the first capillary channels (103) to the intermediate chambers (105). In one example, the capillary breaks (104) are formed and dimensioned to allow for at least as small as a 0.01 μL resolution metering of fluid. In other words, the fluid may be drawn from the capillary channels (103) and past the capillary breaks (104) at a volume of at least as small of as 0.01 μL. The capillary breaks (104) may be formed as a number of protrusions at the end of each of the first capillary channels (103) and serve to preclude movement of the fluid out of the first capillary channels (103) and into the intermediate chambers (105) until a number of electrodes are actuated. The actuation of associated electrodes and their role in fluid movement from the first capillary channels (103), past the capillary breaks (104) and into the intermediate chambers (105) is described in more detail herein.

Any number of intermediate chambers (105) may be included in the channel layer (101). The intermediate chambers (105) may be defined in the channel layer (101) such that they line up with a number of electrodes disposed on a die coupled to the channel layer (101). The movement of fluid from the first capillary channels (103) through the intermediate channels (105) and into the second capillary channels (106) enables a number of fluids to be moved from a number of sample wells (102) to a number of mixing chambers (107). In one example, the intermediate chambers (105) may be fluidically coupled to one another such that the fluids may move between intermediate chambers (107) in order to allow the fluids to flow to mixing chambers (107) that may be located at even remote portions in the microfluidic device into which the channel layer (101) is included.

The mixing chambers (107) may be provided to allow for a plurality of fluids to be mixed. This allows for chemical reactions to take place so that samples may be prepared and analytes may be detected within the fluids and the reacted combinations of the fluids. In one example, a number of pillars may be included within a number of the mixing chambers (107) to allow for the fluids to be drawn into a common portion of the mixing chambers (107) and encourage mixing of the fluids.

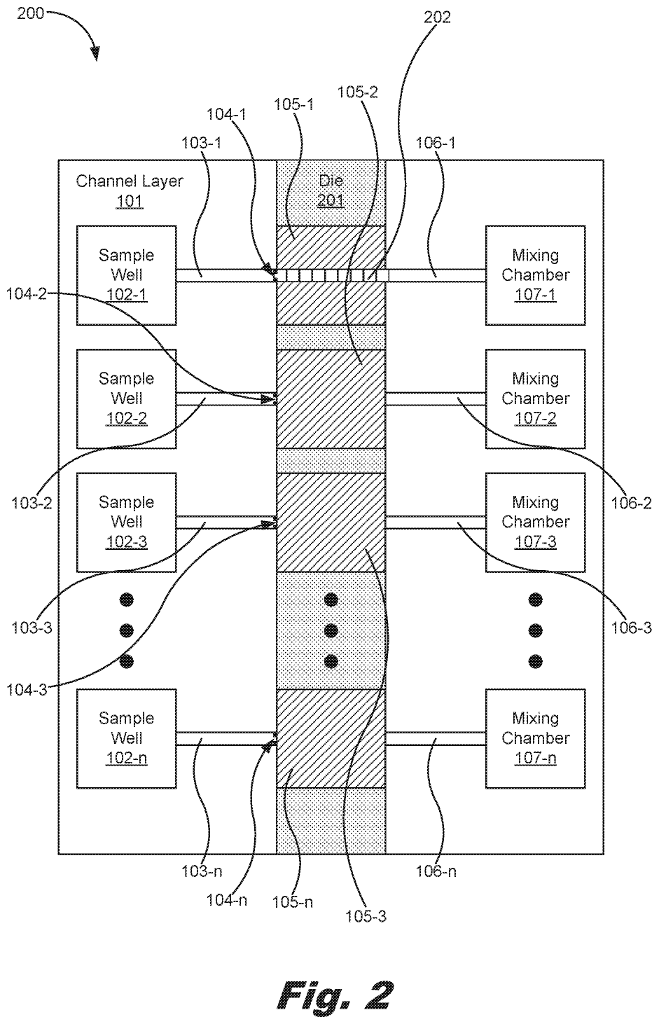

FIG. 2 is a block diagram of a microfluidic electrode array (200), according to an example of the principles described herein. The microfluidic electrode array (200) may include a number of elements including the channel layer (101) described in connection with FIG. 1. Therefore, similarly-numbered elements included in FIG. 1 and described in connection with FIG. 1 designate similar elements within the microfluidic electrode array (200) of FIG. 2.

The microfluidic electrode array (200) may include a die (201). The die (201) may be made of a semiconducting material such as, for example, silicon. A number of electrodes (202) may be fabricated on top of the die (201). In one example, the die (201) may be a sliver die. A sliver die (201) includes a thin silicon, glass, or other substrate having a thickness on the order of approximately 650 micrometers (μm) or less, and a ratio of length to width of at least three.

In one example, the microfluidic electrode array (200) may include at least one die (201) compression molded into a monolithic body of plastic, epoxy mold compound (EMC), or other moldable material. The molding of a die (201) within a moldable material enables the use of smaller dies by offloading the costs that may otherwise be found in forming an entire substrate from silicon or other semiconducting material. More regarding the moldable material is described herein.

The electrodes (202) may be disposed on the die (201) to provide for fluids within the first (103) and second (106) capillary channels to be moved from the first capillary channels (103), through the capillary breaks (104), into the intermediate chambers (105), and into the second capillary channels (106). In one example, the activation of the electrodes (202) causes the fluid to be pulled past the capillary breaks (104), overcoming surface tension caused by cohesion within the fluids and adhesive forces between the fluids and the various voids within the first capillary channels (103) and overcoming the pressure caused by the capillary breaks (104). The electrodes (202) may be fired in a sequential manner to drive, through an electrowetting force, a number of droplets or other volumes of the fluid from the capillary breaks (104), and through the intermediary channels (105) to the second capillary channels (106). More regarding the conveyance of the fluid using the capillary forces and electrodes is describe herein. Electrowetting is a process of applying an electrical field in order to modify the wetting properties of a surface such as a hydrophobic surface. Using the property of electrowetting, the fluids within the microfluidic device may be discretized and programmably manipulated using signals sent to the electrodes (202). In this manner, the microfluidic systems and devices described herein may be referred to as digital microfluidic systems and devices.

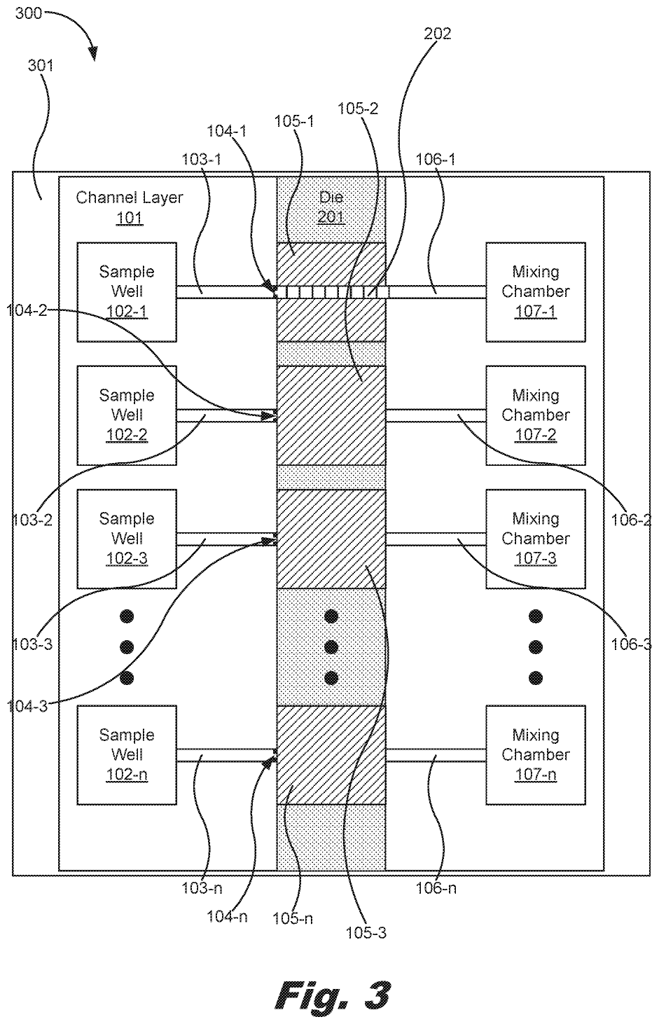

FIG. 3 is a block diagram of a microfluidic system, according to an example of the principles described herein. The microfluidic system (300) may include a number of elements including the channel layer (101) and die (201) and their respective elements described in connection with FIGS. 1 and 2. Therefore, similarly-numbered elements included in FIGS. 1 and 2, and described in connection with FIGS. 1 and 2 designate similar elements within the microfluidic system (300) of FIG. 3. The microfluidic system (300) of FIG. 3 may include a printed circuit assembly (PCA) (301) electrically coupled to the electrodes (202). The PCA (301) may control the activation of the electrodes (202), provide computing and processing resources for a number of actuator and sensors included in the microfluidic system (300), and provide electrical power to the microfluidic system (300), among other tasks as is described herein. The PCA (301) also provides an interface between the microfluidic system (300) and a computing device that may be used to obtain data from the microfluidic system (300) and process the data in determining a number of properties of the fluids involved and samples prepared in the microfluidic system (300), and detecting and detecting properties of analytes within chemical reaction between the fluids.

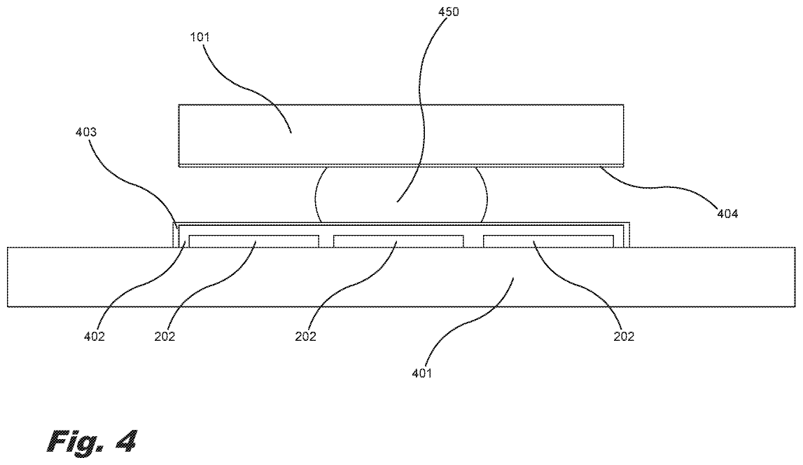

FIG. 4 is a block diagram of an electrode array moving a fluid (450), according to an example of the principles described herein. In providing more detail regarding the electrodes (202) and their function in moving fluids along a path formed by a number of electrodes (202), the microfluidic electrode array (200) may include a substrate (401) that supports the electrodes (202). The substrate (401) may be, for example, the die (201). A layer of dielectric material (402) may be disposed over the electrodes (202) in order to electrically insulate the electrodes (202) from any electrical interaction with the fluids (450) or with other elements of the microfluidic system (300).

A layer of hydrophobic material (403) may be deposited over the dielectric layer (402). The hydrophobic layer (403) decrease the surface energy of a droplet or mass of the fluid such as a droplet of the fluid (450). This reduction in the surface energy provided by the hydrophobic layer (403) reduces the force it takes to move the fluid (450) through the various voids within the channel layer (101). A second hydrophobic layer (404) may also be placed on the channel layer (101) to provide the same result. With this configuration, the fluid (450) is able to be moved through the voids within the channel layer (101) as described herein.

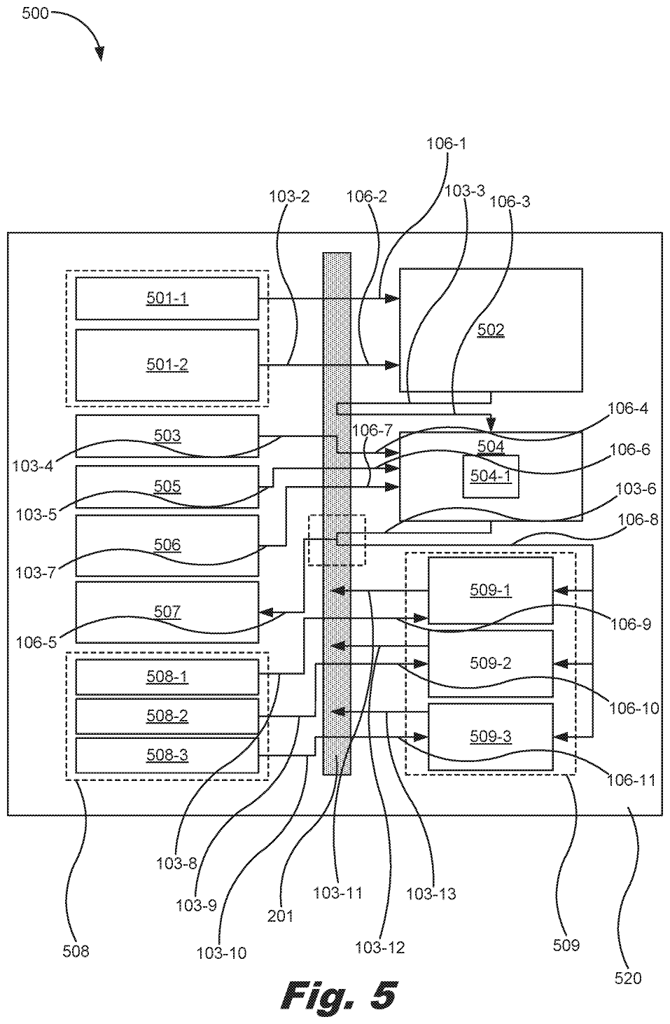

FIG. 5 is a block diagram of a microfluidic device (500), according to another example of the principles described herein. The microfluidic device (500) may include a number of elements including the channel layer (101) and die (201) and their respective elements described in connection with FIGS. 1 through 3. Therefore, similarly-numbered elements included in FIGS. 1 through 3, and described in connection with FIGS. 1 through 3 designate similar elements within the microfluidic device (500) of FIG. 5. In the example of FIG. 5, the die (201) may be overmolded or molded into an overmold material (520) such as EMC. This overmolding of the die (201) results in a much less expensive microfluidic device since the size of the die (201) is decreased and uses relatively less silicon that is relatively more expensive than the moldable material (520).

Further, FIG. 5 provides an example of how fluids with in the microfluidic device (500) may be moved throughout the microfluidic device (500). The boxes depicted within FIG. 5 represent a number of wells and chambers (102, 105, 107), and their purpose and functions are described herein. Further, the arrows represent a number of capillary channels (104, 106) through which the fluids move between the wells and chambers (102, 105, 107). The example of FIG. 5 may include a sample well (501-1) and a lysate reagent well (501-2) as part of an initial sample group (502). In one example, the sample well (501-1) may include a sample of biological material such as, for example, blood. Further, the biological material may have undergone any number of pre-modifications such as, in this example, the addition of an anticoagulant to the blood, addition of a diluent to improve flow of the blood through the microfluidic device (500), or other pre-introduction processes.

In one example, the biological material may be introduced into the sample well (501-1) of the initial sample group (502) using a sample aperture located above the sample well (501-1) and formed in a lid that covers the channel layer (101). The lid is described in more detail herein. Thus, using the sample aperture in the lid, the biological material may be introduced into the sample well (501-1) for analysis and/or other processing.

Further, in one example, the lysate reagent contained in the lysate reagent well (501-1) may be introduced into the lysate reagent well (501-2) using a blister pack fluidically coupled to the lysate reagent well (501-2). In this example, a via may be formed through, for example, the moldable material (501) to allow the lysate reagent contained in the blister pack to be moved from the blister pack to the lysate reagent well (501-2) of the initial sample group (502).

Two capillary channels (103-1, 103-2) are coupled to the sample well (501- and a lysate reagent well (501-2), respectively, to allow the fluids within the sample well (501-1) and a lysate reagent well (501-2) to be drawn out and into respective intermediate chambers (105). In one example, the activation of the electrodes (202) causes the fluid to be pulled past the capillary breaks (104), overcoming surface tension caused by cohesion within the fluids and adhesive forces between the fluids and the various voids within the capillary channels (103) and overcoming the pressure caused by the capillary breaks (104). The electrodes (202) may be fired in a sequential manner to drive, through an electrowetting force, a number of droplets or other volumes of the fluid from the first capillary channels (103-1, 103-2) and the capillary breaks (104), and through the intermediary channels (105) to the second capillary channels (106-1, 106-2).

The second capillary channels (106-1, 106-2) move the fluids into a first mixing chamber (502). In the example of FIG. 5, the two fluids interact and react with one another to bring about the lysis of the biological material from the sample well (501-1) using the lysate reagent introduced into the first mixing chamber (502) from the lysate reagent well (501-2). In this manner, the microfluidic device (500) brings about cell lysis of the biological material.

The microfluidic device (500) may continue to process the fluids by providing movement of the fluids from the first mixing chamber (502) to other portions of the microfluidic device (500) using additional capillaries and electrodes within the microfluidic device (500). For example, the mixture from the first mixing chamber (502) including the lysis-processed biological material may be draw from the first mixing chamber (502) using the capillary forces provided by another capillary channel (103-3) and to a respective capillary break (104) located within the capillary channel (103-3). Here, it is noted that the capillary channel (103-3) exiting the first mixing chamber (502), even though being located on an opposite side of the microfluidic device (500) relative to capillary channel (103-1, 103-2), includes a capillary break (104). This allows the same process of fluid extraction from the capillary channel (103-3) to be accomplished as described herein in connection with other capillary channels (103) and their associated electrodes (202). In this manner, when a fluid is extracted from a well or chamber, the fluid may be drawn out using capillary forces provided by the capillary channels (103), and stopped at the interface of the electrodes (202) using the capillary breaks (104) in order to digitally address the electrodes (202) and meter or measure out a discrete amount of fluid from the wells or chambers.

The mixed fluid from the first mixing chamber (502) may be directed, using the actuation of the electrodes (202), to a magnetic trap chamber (504). The example of FIG. 5 includes a movement of the fluid introduced to the die (201) within an intermediate chamber (105) in a direction perpendicular to the travel of fluid into the intermediate chamber (105). As is described herein in more detail, the electrodes may be arranged along a longitudinal axis of the die (201) to allow the fluids moved by the electrodes to be moved along the longitudinal axis of the die (201) and into second capillary channels (106) that are not horizontally aligned with corresponding first capillary channels (103). The mixed fluid from the first mixing chamber (502) may be directed, using the electrodes, into capillary channel (106-3) and into the magnetic trap chamber (504).

Further, a number of additional fluids may be drawn into the magnetic trap chamber (504) from, for example, a silicon slurry well (503) from which a slurry of magnetic silica beads may be drawn. In one example, the slurry of magnetic silica beads may be provided via a blister pack. As similarly described above in connection with the lysate reagent well (501-2), a blister pack may be fluidically coupled to the silicon slurry well (503) to allow for the slurry of magnetic silica beads to be introduced into the silicon slurry well (503).

The slurry of magnetic silica beads may be drawn from the silicon slurry well (503) through capillary channel (103-4) and its associated capillary break (104), and into an intermediate chamber (105). In the example, the slurry of magnetic silica beads may be moved along the longitudinal axis of the die (201) and into capillary channel (106-4) and the magnetic trap chamber (504).

In the example of FIG. 5, the magnetic trap chamber (504) may include a magnet (504-1) to draw the magnetic silica beads to the magnet (504-1) and trap the lysis-processed biological material drawn from the first mixing chamber (502) into the magnetic trap chamber (504). The fluids within the magnetic trap chamber (504) may be drawn from the magnetic trap chamber (504) through capillary channel (103-6), an associated capillary break (104) and intermediate chamber (105), into capillary channel (106-5) and a waste chamber (507). In this manner, the waste from the lysis-processed biological material may be removed from the process to allow for other processes to be performed on the remaining constituents.

In the example of FIG. 5, a wash buffer may be drawn from a wash buffer well (505), through capillary channel (103-5), an associated capillary break (104) and intermediate chamber (105), and into a capillary channel (106-6) fluidically coupled to the magnetic trap chamber (504). The wash buffer from the wash buffer well (505) may be used to clean any unnecessary or unwanted fluids and solids from the trapped lysis-processed biological material and magnetic silica beads. The wash buffer may then be moved from the magnetic trap chamber (504) to the waste chamber (507) through capillary channel (103-6), an associated capillary break (104) and intermediate chamber (105), into capillary channel (106-5) and the waste chamber (507).

An elution buffer used to extract one material from another by washing with a solvent may be moved from an elution buffer well (506), through capillary channel (103-7), an associated capillary break (104) and intermediate chamber (105), and into capillary channel (106-7) fluidically coupled to the magnetic trap chamber (504). The elution buffer from the elution buffer well (506) causes deoxyribonucleic acid (DNA) to be released from the particles of trapped lysis-processed biological material.

The resultant elution buffer and DNA may be split and moved from the magnetic trap chamber (504) to a number of master mix chambers (509-1, 509-2, 509-3) among a group (509) of master mix chambers through capillary channel (103-6), the associated capillary break (104) and intermediate chamber (105), into capillary channel (106-8) that includes a number of branching capillary channels extending therefrom, and into a number of the master mix chambers (509-1, 509-2, 509-3) each of which is coupled to a branch of capillary channel (106-8).

In one example, a number of reagents from among of a group (508) of reagent wells (508-1, 508-2, 508-3) may be moved to the master mix chambers (509-1, 509-2, 509-3) respectively via capillary channels (103-8, 103-9, 103-10), through respective associated capillary breaks (104) and intermediate chambers (105), and into respective capillary channels (106-9, 106-10, 106-11) fluidically coupled to a respective one of the master mix chambers (509-1, 509-2, 509-3).

In one example, a number of sensors may be included in the microfluidic device (500). The sensors in the example of FIG. 5 may be any sensor that may detect at least one property of the fluids within the master mix chambers (509-1, 509-2, 509-3). In one example, the sensors may be located within the master mix chambers (509-1, 509-2, 509-3). In another example, the sensors may be located on the die (201). In this example, a volume of the fluids may be moved from a respective master mix chambers (509-1, 509-2, 509-3) to a sensor on the die (201) via capillary channels (103-11, 103-12, 103-13) and their respective capillary breaks (104) onto the die (201). Further, in this example, the sensors may be located on the die (201) and within a respective intermediate chamber (105) of the channel layer (101). More details regarding sensors and their inclusion in the microfluidic device is described herein.

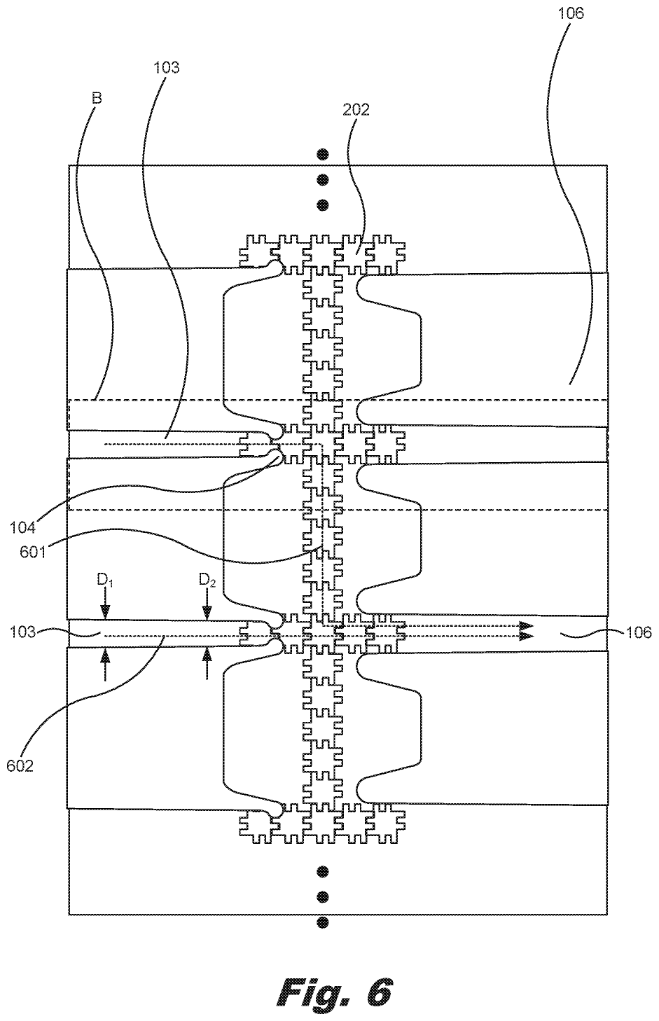

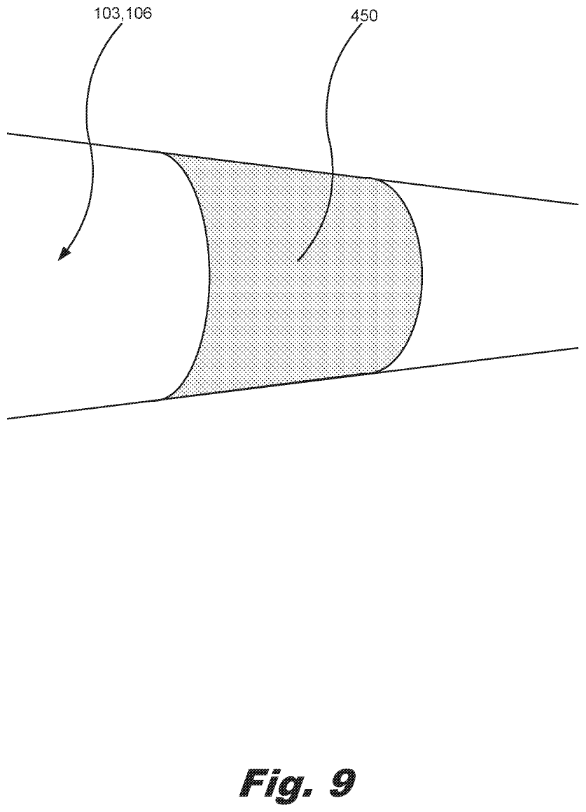

FIG. 6 is a diagram of a number of capillary channels (103, 106), capillary breaks (104), and electrodes (202) within box A of FIG. 5, according to an example of the principles described herein. FIG. 6 includes a number of elements including the channel layer (101) and die (201) and their respective elements described in connection with FIGS. 1 through 3 and 5. Therefore, similarly-numbered elements included in FIGS. 1 through 3 and 5, and described in connection with FIGS. 1 through 3 and 5 designate similar elements within FIG. 6. The capillary channels (103, 106) of the microfluidic device (500) include a tapered geometry such that the capillary channels (103, 106) taper in the direction the fluid is to travel through the capillary channels (103, 106). In other words, D₁ of capillary channel (103) is wider than D₂, and D₃ of capillary channel (106) is wider than D₄ if the flow of fluid is in the direction of arrows 601 or 602. With reference to FIG. 9, FIG. 9 is a diagram of a capillary flow of fluid (450) through a capillary channel (103, 106), according to an example of the principles described herein. The fluid (450) flows due to a balance of capillary forces. The air pressure within the capillary channels (103, 106) may be defined as follows:

$$Δ {p}_{total} = ( Δ {p}_{1} - Δ {p}_{2} ) = k ( \frac{1}{{R}_{1}} - \frac{1}{{R}_{2}} )$$

where R₁ is the radius of the capillary channel (103, 106) behind the fluid (450) at the relatively larger radius of the capillary channel (103, 106), R₂ is the radius of the capillary channel (103, 106) in front of the fluid (450) at the relatively smaller radius of the capillary channel (103, 106), Δp₁ is the pressure drop across the air-fluid interface at point (601), Δp₂ is the pressure drop across the air-fluid interface (602), and Δpₜₒₜₐₗ is the total pressure drop across the air-fluid interfaces (601, 602), and k is a proportionality constant that depends on the properties of the fluid (450) and the surface energy of the surfaces of the capillary channel (103, 106). The tapering of the Thus, in this manner, without the use of internal or external pumps, the fluid is able to flow in the direction of the decreasing radius of the capillary channels (103, 106).

In FIG. 6, the ellipses indicate a repeating pattern of capillary channels (103, 106), capillary breaks (104), and electrodes (202) along a length of the die (201) and the channel layer (101). In one example, the pattern of electrodes may repeat any number of times to form a heterogenous electrode layout throughout the length of the die (201). With this heterogenous die (201), a different channel layer (101) may be coupled thereto based on a desired routing of fluids, and, in turn, a different function in the microfluidic device (500). This allows for the die (201) to be created independent of the formation of the channel layer (101). Thus, in order to obtain a microfluidic device (500) with a desired function, the channel layer (101) may be changed rather than changing more elements or an entirety of the microfluidic device (500). This greatly increases the manufacturability of the microfluidic device (500) and reduces costs associated with manufacturing the microfluidic device (500).

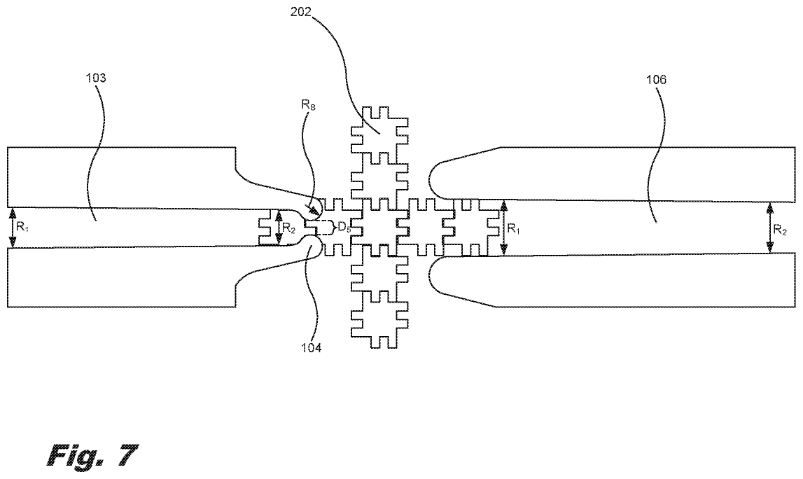

FIG. 7 is a diagram of a number of capillary channels (103, 106), capillary breaks (104), and electrodes (202) of FIG. 6 within box B of FIG. 6, according to an example of the principles described herein. FIG. 7 includes a number of elements including the channel layer (101) and die (201) and their respective elements described in connection with FIGS. 1 through 3, 5, and 6. Therefore, similarly-numbered elements included in FIGS. 1 through 3, 5, and 6, and described in connection with FIGS. 1 through 3, 5, and 6 designate similar elements within FIG. 7. With the background of FIGS. 6 and 9, R₁ defines a diameter and a subsequent radius of a first portion of the capillary channels (103, 106) that is relatively larger than R₂ that defines a diameter and a subsequent radius of a second portion of the capillary channels (103, 106). In one example, R₁ may be approximately between 150 μm and 130 μm and R₂ may be between 100 μm and 80 μm.

RB defines the radius of the capillary breaks (104). The capillary breaks (104) located between the capillary channels (103) and the intermediate chambers (105) may include radial projections that protrude into the capillary channels (103) and the intermediate chambers (105). In one example, RB may be approximately 30 μm.

D₅ is the distance within the void created by the capillary break (104). In one example, D₅ may be approximately 70 μm. D₅ may be small enough to stop the fluid from freely moving into the intermediate chambers (105), but large enough to allow the actuation of the electrodes (202) to force a discrete amount of the fluid (450) through the capillary breaks (104) and into the intermediate chamber (105).

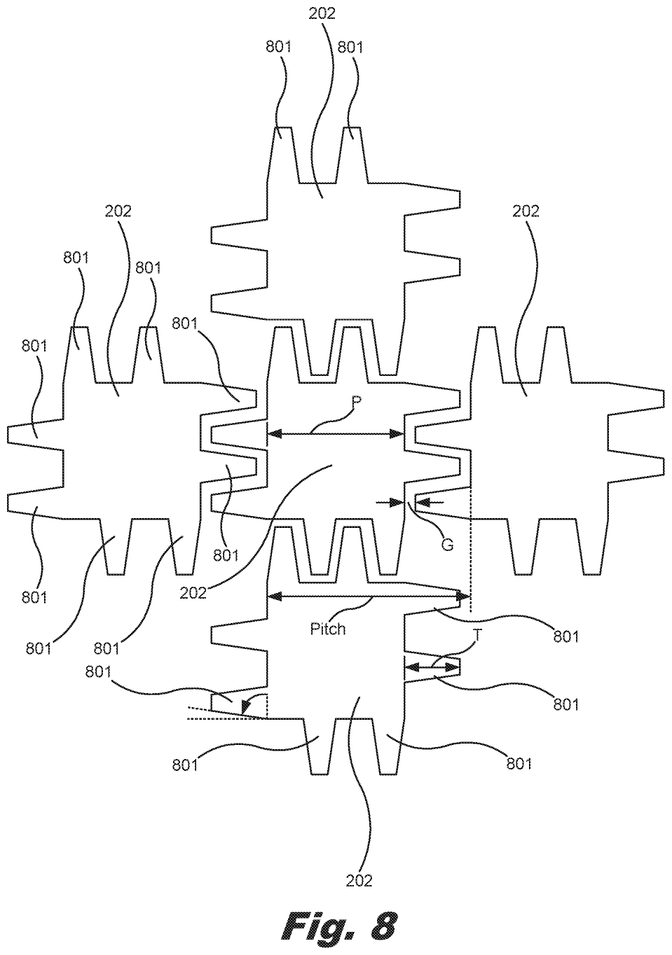

FIG. 8 is a diagram of a number of electrodes (202), according to an example of the principles described herein. The electrodes may include a number of protrusions (801). The protrusions (801) serve to alter the force asserted by the electrodes (202) in the fluid (450). In one example, each electrode (202) may include eight protrusions (801). Further, each protrusion (801) of each electrode (202) may have a length T of approximately between 25 μm and 35 μm. The size P of the center portion of the electrodes (202) minus the length of the protrusions (801) may be between approximately 85 μm and 90 μm. The gap G between neighboring electrodes (202) may be between 1 μm and 2 μm. The pitch of the layout of the electrodes (202) may be between 100 μm and 130 μm. Further, each protrusion (801) may have a trapezoidal shape where the sides of the protrusions (801) include angle A of between 90 degrees and 60 degrees. These values, however, are examples, and any combination of values may be used to obtain an effective electrode array within the microfluidic device (500).

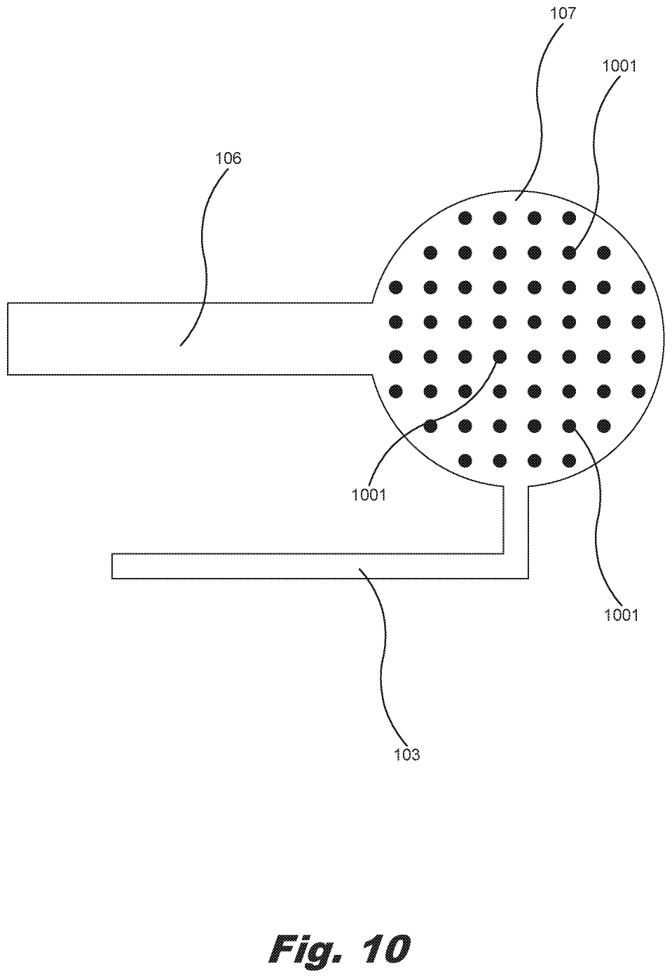

FIG. 10 is a diagram of a mixing chamber (107), according to an example of the principles described herein. The mixing chamber (107) may be fluidically coupled to a second capillary channel (106) and a first capillary channel (103) are similarly described above in connection with FIGS. 1 through 3 and 5 through 7 in order to draw fluid (450) into the mixing chamber (107), and supply a mixed fluid to another portion of the microfluidic device (500). In the example of FIG. 10, the mixing chamber (107) may include a number of pillars (1001). The pillars (1001) serve as a type of wick to draw the fluid (450) into the mixing chamber (107) and allow for a plurality of fluids to interact and mix. The pillars (1001) may be included in any number of chambers and wells within the microfluidic device (500).

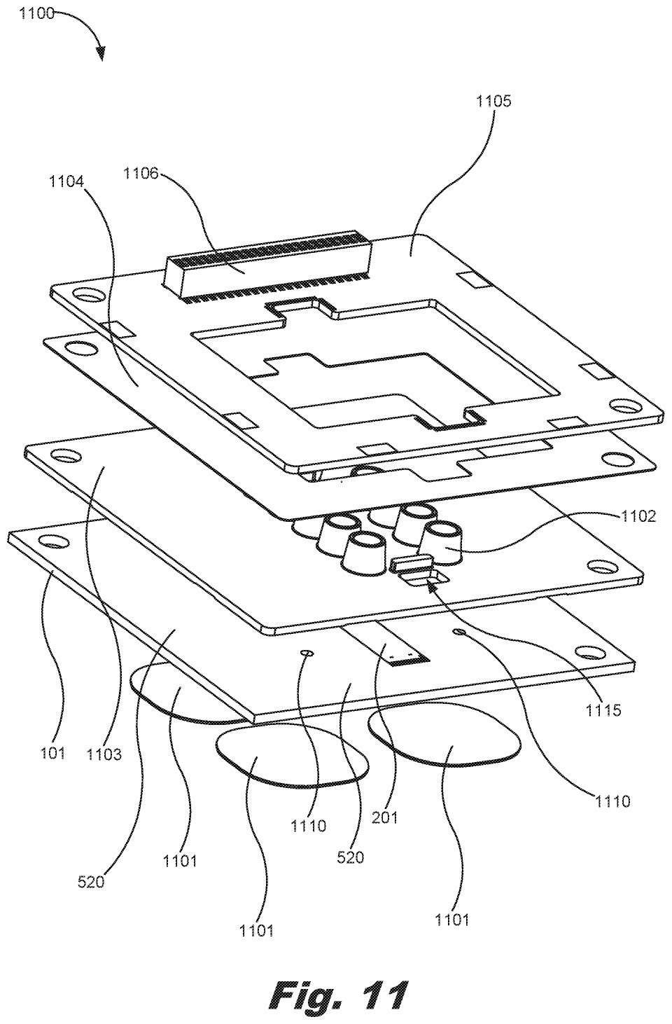

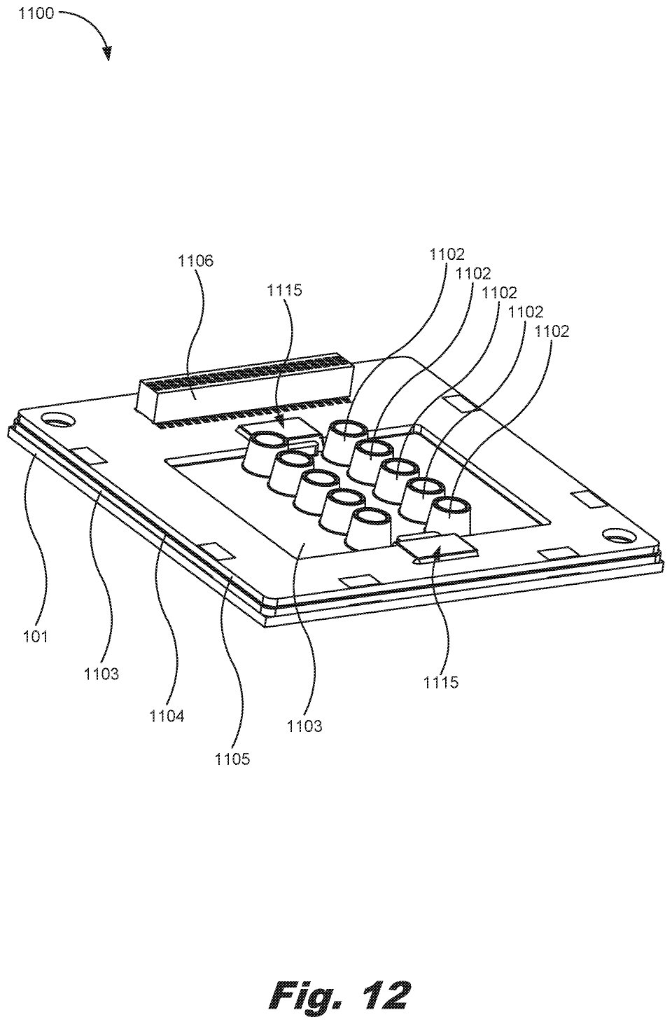

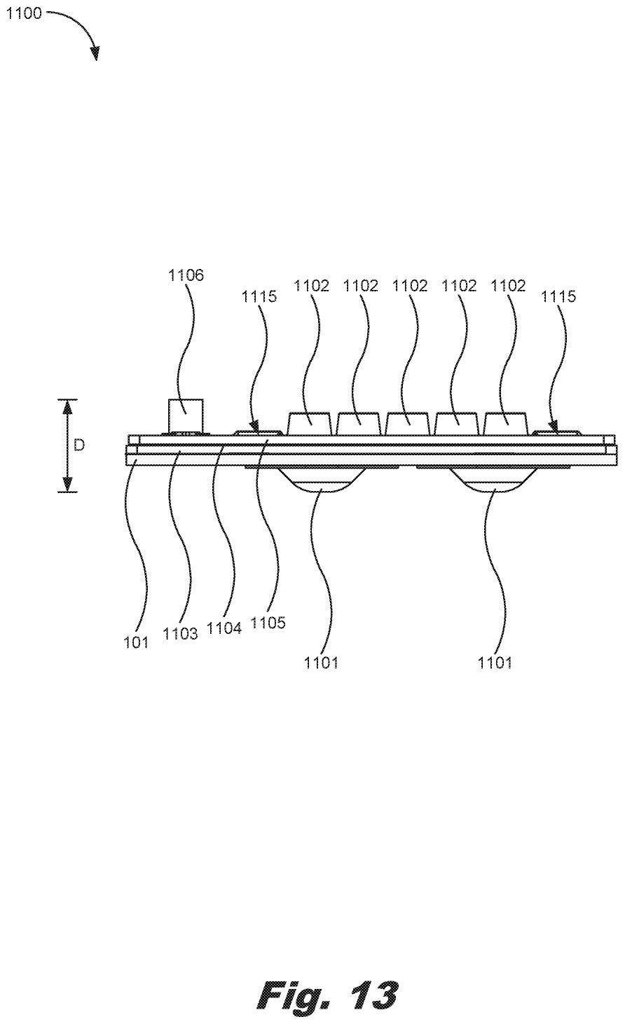

FIG. 11 is an exploded view of a microfluidic system (1100), according to an example of the principles described herein. Further, FIG. 12 is an axonometric view of a microfluidic system (1100), according to an example of the principles described herein. Still further, FIG. 13 is a side view of a microfluidic system (1100), according to an example of the principles described herein. FIGS. 11 through 13 include a number of elements including the channel layer (101) and die (201) and their respective elements described in connection with FIGS. 1 through 3, and 5 through 7. Therefore, similarly-numbered elements included in FIGS. 1 through 3, and 5 through 7, and described in connection with FIGS. 1 through 3, and 5 through 7 designate similar elements within FIGS. 11 through 13. The microfluidic system (1100) may include a number of blister packs (1101) coupled to a side of the moldable material (520) and fluidically coupled to the channel layer (101) through vias (1110) in, for example, the moldable material (520). The blister packs (1101) may be used to dispense a fluid such as the lysate reagent described herein available within the lysate reagent well (501-2).

The die (201) is depicted in FIG. 11 as being overmolded into the moldable material (520). The channel layer (101) is coupled to the overmolded die (201, 520) and aligned with a number of the electrodes (202) on the die (201) to provide for the transmission of fluids (450) within the microfluidic system (1100) as described herein.

A lid (1103) may be coupled to the channel layer (101). In one example, the lid (1103) serves as one side of the various capillary channels (103, 106), wells (102), intermediate chambers (105), mixing chambers (107), other voids within the channel layer (101), and combinations thereof. In another example, the voids within the channel layer (101) may be formed entirely within the channel layer (101).

In still another example, the lid (1103) may serve as at least one side of the intermediate chambers (105). In this example, the interface between the intermediate chambers (105) and the lid (1103) forms openings (1115) at either end of the die (201). The openings (1115) provide for the free movement of air within the microfluidic system (1100) to allow the fluids (450) to freely move within the system. In this manner, the openings (1115) act as a kind of atmospheric ground to allow the pressures existent within the microfluidic system (1100) to equalize and allow the fluids (450) to freely flow throughout the voids within the channel layer (101).

Further, in one example, the lid (1103) may include a number of well apertures (1102) formed therein. The well apertures (1102) may be fluidically coupled to a number of the capillary channels (103, 106), wells (102), intermediate chambers (105), mixing chambers (107), other voids within the channel layer (101), and combinations thereof. The well apertures (1102) allow for a user to introduce a fluid (450) into the microfluidic system (1100) as part of the fluid processing of the microfluidic system (1100).

A pressure-sensitive adhesive (1104) may be applied between the lid (1103) and a printed circuit assembly (PCA) (1105) to couple the lid (1103) to the PCA (1105). The PCA (1105) may be any combination of electrical circuits, printed circuit boards, and electrical connections that electrically couple the electrodes (202) to a power and signal source. The RCA (1105) may include an input-output interface (1106) to allow the microfluidic system (1100) to be coupled to a data processing device such as a computing device with a processor and memory.

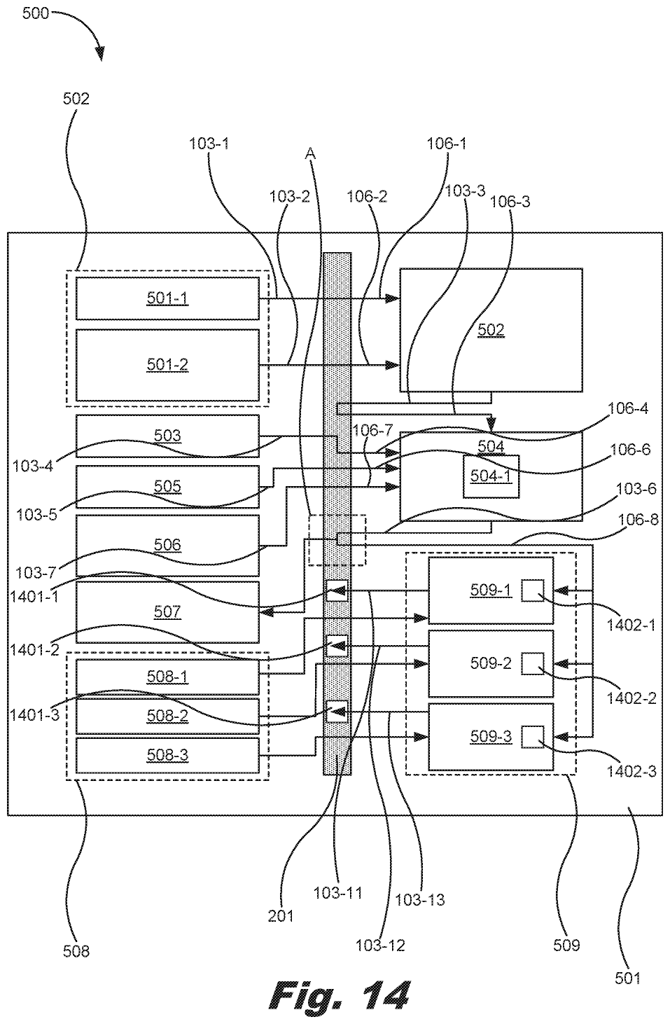

FIG. 14 is a block diagram of a microfluidic device (500), according to another example of the principles described herein. FIG. 14 includes a number of elements including the channel layer (101) and die (201) and their respective elements described in connection with FIGS. 1 through 3, 5 through 7, and 11 through 13. Therefore, similarly-numbered elements included in FIGS. 1 through 3, 5 through 7, and 11 through 13, and described in connection with FIGS. 1 through 3, 5 through 7, and 11 through 13 designate similar elements within FIG. 14. The example of FIG. 14 includes a number of sensors, actuators, and other fluid detection and manipulation devices in order to provide feedback to, for example, a data processing system such as a computing device including a processor and memory.

For example, the microfluidic system (500) may include a number of sensors (1401-1, 1401-2, 1401-3, 1402-1, 1402-2, 1402-3) in the microfluidic device (500). The sensors (1401-1, 1401-2, 1401-3, 1402-1, 1402-2, 1402-3) in the example of FIG. 14 may be any sensor that may detect at least one property of the fluids within the master mix chambers (509-1, 509-2, 509-3) or elsewhere within the microfluidic device (500). In one example, the sensors (1402-1, 1402-2, 1402-3) may be located within the master mix chambers (509-1, 509-2, 509-3). In this example, a number of dielectric layers, passivation layers, or other layers may be interposed between the sensors (1402-1, 1402-2, 1402-3) and the fluid (450) in order to ensure that the sensors (1402-1, 1402-2, 1402-3) are not adversely effected by the fluids (450) and visa versa.

In another example, the sensors (1401-1, 1401-2, 1401-3) may be located on the die (201). In this example, a volume of the fluids (450) may be moved from a respective master mix chambers (509-1, 509-2, 509-3) to a respective sensor (1402-1, 1402-2, 1402-3) on the die (201) via capillary channels (103-11, 103-12, 103-13) and their respective capillary breaks (104) onto the die (201). Further, in this example, the sensors (1401-1, 1401-2, 1401-3) may be located on the die (201) and within a respective intermediate chamber (105) of the channel layer (101). Other sensing devices including, for example, spectrometers, optical sensors, density sensors, or other types of sensors that detect at least one property of the fluids included or processed within the microfluidic system (500).

In another example, a number of actuators may be included within the microfluidic system (500). As described herein, the magnet (504-1) included within the magnetic trap chamber (504) is an actuator used to draw the magnetic silica beads to the magnet (504-1). However, other actuators including, for example, fluid pumps, heating devices, cooling devices, heat sinks, light emitting devices, other actuation devices, or combinations thereof.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, a processor electrically coupled to the microfluidic electrode array (200) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe q channel layer of a digital microfluidic device. The channel layer may include a number of sample wells located on a first side of the die, a number of first capillary channels fluidically coupled to each of the sample wells, the first capillary channels drawing a fluid from the sample wells using capillary forces, a capillary break fluidically coupled to each of the first capillary channels to dispense a portion of the fluid drawn from the sample wells through the capillary forces, a number of intermediate chambers fluidically coupled to the capillary break, a number of second capillary channels fluidically coupled to the intermediate chambers, the second capillary channels drawing the fluid from the intermediate chambers using capillary forces, and a number of mixing chambers fluidically coupled to the second capillary channels into which the capillary forces of the second capillary channels cause the fluid to enter the mixing chambers.

The systems and methods described herein provide for an inexpensive and small electrically-driven microfluidic device with high digital precision as to its ability to move precisely-metered amount of fluids. Further, the channel layer of the present systems is extremely easy to design, and is modular and reprogrammable such that it can be easily tuned to perform a different assay by changing the order of actuation of the electrodes on the die. Further, the moldable material even further reduces the cost of manufacturing the microfluidic system.

The preceding description has been presented to illustrate and describe examples of the principles described. This description is not intended to be exhaustive or to limit these principles to any precise form disclosed. Many modifications and variations are possible in light of the above teaching.

What is claimed is:

1. A digital microfluidic electrode array (DMFEA), comprising:
at one least one die comprising a number of electrodes disposed along a surface of the die; and
a channel layer coupled to the die, the channel layer comprising:
a number of sample wells located on a first side of the die;
a number of first capillary channels fluidically coupled to each of the sample wells, the first capillary channels drawing a fluid from the sample wells using capillary forces;
a capillary break fluidically coupled to each of the first capillary channels to dispense a portion of the fluid drawn from the sample wells through the capillary forces;
a number of intermediate chambers fluidically coupled to the capillary break;
a number of second capillary channels fluidically coupled to the intermediate chambers, the second capillary channels drawing the fluid from the intermediate chambers using capillary forces; and
a number of mixing chambers fluidically coupled to the second capillary channels into which the capillary forces of the second capillary channels cause the fluid to enter the mixing chambers,
wherein the electrodes cause the fluid to move out of the first capillary channels through the capillary break; through the intermediate chambers, and into the second capillary channels.

2. The DMFEA of claim 1, wherein the electrodes are positioned on the die based on a pattern.

3. The DMFEA of claim 2, wherein the first capillary channels, the capillary breaks, the intermediate chambers, and the second capillary channels are positioned based on the pattern of the electrodes.

4. The DMFEA of claim 1, the channel layer comprises an overmold material overmolding at least a portion of the die and coplanar to a side of the die on which the electrodes are disposed.

5. The DMFEA of claim 4, wherein the overmold material is an epoxy mold compound (EMC).

6. The DMFEA of claim 1, wherein the first capillary channels and second capillary channels comprise a tapered geometry.

7. The DMFEA of claim 1, wherein the intermediate chambers are open to atmosphere.

8. A microfluidic system, comprising:
a digital microfluidic electrode array (DMFEA), comprising at one least one die comprising a number of electrodes disposed along a surface of the die;
a channel layer comprising:
a number of sample wells located on a first side of the die;
a number of first capillary channels fluidically coupled to each of the sample wells, the first capillary channels drawing a fluid from the sample wells using capillary forces;
a capillary break fluidically coupled to each of the first capillary channels to dispense a portion of the fluid drawn from the sample wells through the capillary forces;
a number of intermediate chambers fluidically coupled to the capillary break;
a number of second capillary channels fluidically coupled to the intermediate chambers, the second capillary channels drawing the fluid from the intermediate chambers using capillary forces; and
a number of mixing chambers fluidically coupled to the second capillary channels into which the capillary forces of the second capillary channels cause the fluid to enter the mixing chambers,
wherein the electrodes cause the fluid to move out of the first capillary channels through the capillary break, through the intermediate chambers, and into the second capillary channels; and
a printed circuit assembly (PCA) electrically coupled to the electrodes, the PCA controlling the activation of the electrodes.

9. The microfluidic system of claim 8, wherein:
the channel layer comprises an overmold material overmolding at least a portion of the die and coplanar to a side of the die on which the electrodes are disposed; and
wherein the sample wells, the first capillary channels, the intermediate chambers, the second capillary channels, the mixing chambers, or combinations thereof are defined in the channel layer.

10. The microfluidic system of claim 8, further comprising a lid layer disposed between the die and the PCA.

11. The microfluidic system of claim 8, wherein the lid layer comprises a cyclic olefin copolymer (COC).

12. The microfluidic system of claim 8, further comprising a number of blister packs fluidically coupled to the first capillary channels, the intermediate chambers, the second capillary channels, the mixing chambers, or combinations thereof.

13. The microfluidic system of claim 8, further comprising a number of sensors positioned relative to the first capillary channels, the intermediate chambers, the second capillary channels, the mixing chambers, or combinations thereof to detect a number of properties of the fluid.

14. A channel layer of a digital microfluidic device, comprising:
a number of sample wells located on a first side of the die;
a number of first capillary channels fluidically coupled to each of the sample wells, the first capillary channels drawing a fluid from the sample wells using capillary forces;
a capillary break fluidically coupled to each of the first capillary channels to dispense a portion of the fluid drawn from the sample wells through the capillary forces;
a number of intermediate chambers fluidically coupled to the capillary break;
a number of second capillary channels fluidically coupled to the intermediate chambers, the second capillary channels drawing the fluid from the intermediate chambers using capillary forces; and
a number of mixing chambers fluidically coupled to the second capillary channels into which the capillary forces of the second capillary channels cause the fluid to enter the mixing chambers.

15. The channel layer of claim 15, wherein the first capillary channels and second capillary channels comprise a tapered geometry.
